(19) United States
(12) Patent Application Publication
(10) Pub. No.: US 2026/0045891 A1
(43) Pub. Date: Feb. 12, 2026

(54) ADAPTIVE COMMUTATION PHASE TUNING FOR ROBUST CONTROL AND OPTIMAL POWER CONSUMPTION IN BRUSHLESS MOTORS

(71) Applicant: Cypress Semiconductor Corporation, San Jose, CA (US)

(72) Inventor: Blesson Easo Varghese, Dakshina Kannada (IN)

(21) Appl. No.: 18/990,284

(22) Filed: Dec. 20, 2024

(30) Foreign Application Priority Data
Aug. 6, 2024 (IN) 202411059285

(51) Int. Cl. H02P 6/15; H02P 6/16; H02P 6/26; H02P 6/28

(52) U.S. Cl. CPC H02P 6/153; H02P 6/16; H02P 6/26; H02P 6/28

(57) ABSTRACT

Described herein is a gradient descent technique for adaptive commutation phase tuning in brushless motors (e.g., such as brushless BLDC motors). In an example embodiment, an integrated circuit (IC) controller for controlling a BLDC motor comprises a first control loop and a second control loop. The first control loop is configured to calculate a duty cycle based on a sensor signal received from a position sensor in the BLDC motor. The second control loop is configured to calculate an updated commutation timing based on a present commutation timing of the BLDC motor and a current measurement representing a current sensed at the BLDC motor. Based on the calculated duty cycle and the updated commutation timing, the IC controller is configured to continuously control commutation in the BLDC motor.

### BACKGROUND

Brushless direct current (BLDC) motors typically operate by using commutation. For example, a control system would perform commutation by first determining the angular position of the motor's rotor and then applying current to the motor's stator to move the rotor to a new position. Electronically controlling such commutation typically relies on some feedback to recognize the current position of the rotor, so the commutation timing with respect to the rotor position is critical in obtaining the best motor performance. However, the commutation timing is dependent on multiple internal and external parameters of motor operation (e.g., such as revolutions per minute (RPM)) of the motor, torque requirements of the particular application, mechanical loading, power consumption, placement of the position sensor, vibration, operating noise, etc.).

One simple conventional method of determining commutation timing is to advance commutation with RPM by measuring the speed of the rotor. However, this method suffers from many disadvantages and cannot guarantee the optimal performance of the motor, not the least because the internal and external motor operation parameters are difficult to account for.

### SUMMARY

According to an embodiment of an integrated circuit (IC) controller for controlling a brushless direct current (BLDC) motor, the IC controller comprises: a first control loop configured to calculate a duty cycle based on a sensor signal received from a position sensor in the BLDC motor; and a second control loop configured to calculate an updated commutation timing based on a present commutation timing of the BLDC motor and a current measurement representing a current sensed at the BLDC motor, wherein the IC controller is configured to continuously control commutation in the BLDC motor based on the calculated duty cycle and the updated commutation timing.

According to an embodiment of a controller for a brushless DC (BLDC) motor having a rotor and a plurality of stator windings and powered by a power supply having a fixed input voltage, the controller comprises: a first control loop configured to adjust a duty cycle of a signal used to commutate current in the stator windings based on a difference between a measured variable and a reference value, such that the measured variable tracks the reference value; and an adaptive control loop configured to dynamically adjust a commutation phase of the current in the stator windings, such that the commutation phase settles at a value that corresponds to a minimum input current of the power supply.

According to an embodiment of a method of controlling a brushless DC (BLDC) motor having a rotor and a plurality of stator windings and powered by a power supply having a fixed input voltage, the method comprises: adjusting a duty cycle of a signal used to commutate current in the stator windings based on a difference between a measured variable and a reference value, such that the measured variable tracks the reference value; and dynamically adjusting a commutation phase of the current in the stator windings, such that the commutation phase settles at a value that corresponds to a minimum input current of the power supply.

### BRIEF DESCRIPTION OF THE DRAWINGS

The disclosure is illustrated by way of example, and not of limitation, in the figures of the accompanying drawings.

FIG. 1A illustrates the structure of a 4-pole single phase BLDC motor that can be used in some embodiments.

FIG. 1B illustrates a mathematical model of a simple single-phase brushless motor.

FIG. 2 illustrates various parameters that can affect commutation timing in brushless motors (e.g., such as BLDC motors).

FIGS. 3A-3H illustrate the relation between torque and commutation timing in brushless motors (e.g., such as BLDC motors) in various embodiments.

FIG. 4 illustrates the relation between angular velocity and commutation timing in brushless motors (e.g., such as BLDC motors) in various embodiments.

FIG. 5 illustrates the relationship between power consumption and commutation timing in brushless motors (e.g., such as BLDC motors) in various embodiments.

FIG. 6A-6D illustrate MATLAB simulation results illustrating the relation between load torque and commutation phase, to show how advancing commutation at higher RPM or higher mechanical load increases the torque by aligning the current waveform with the back EMF (electro-magnetic force).

FIG. 7A is a block diagram illustrating an integrated circuit (IC) controller that can be configured as a proportional integral (PI) controller and an adaptive commutation controller to control the commutation of a BLDC motor in accordance with various embodiments of the present disclosure.

FIG. 7B is a block diagram of a system for control of a BLDC motor in accordance with various embodiments of the present disclosure.

FIG. 8A illustrates an example control block diagram for a gradient descent technique in accordance with various embodiments of the present disclosure.

FIG. 8B illustrates a block diagram of a general current-sense based adaptive control system in accordance with various embodiments of the present disclosure.

FIG. 8C illustrates a graph showing adaptive commutation phase tuning in accordance with the gradient descent technique in accordance with various embodiments of the present disclosure.

FIG. 9 illustrates an example operational graph of the mutual dependence of PI and adaptive control blocks for the adaptive commutation phase control block illustrated in FIGS. 8A-8C.

FIG. 10 illustrates a block diagram of system modeling and system stability overview of a system in accordance with various embodiments of the present disclosure.

FIGS. 11A-11C illustrate waveform diagrams of commutation for a BLDC motor at various loads in accordance with an example embodiment of the present disclosure.

FIG. 12 illustrates a real-time response diagram of adaptive control captured during run-time in accordance with an example embodiment.

FIG. 13 illustrates high-level applications that can be developed using IC controller devices (e.g., such as USB-PD controllers) to support commutation control of BLDC motors in accordance with various embodiments of the present disclosure.

### DETAILED DESCRIPTION

The following description sets forth numerous specific details such as examples of specific systems, components, methods, and so forth, in order to provide a good understanding of various embodiments described herein of a gradient descent technique for adaptive commutation phase tuning for robust control and optimal power consumption in BLDC motors. It will be apparent to one skilled in the art, however, that at least some embodiments may be practiced without these specific details. In other instances, well-known components, elements, or methods are not described in detail or are presented in a simple block diagram format in order to avoid unnecessarily obscuring the techniques described herein. Thus, the specific details set forth hereinafter are merely exemplary. Particular implementations may vary from these exemplary details and still be contemplated to be within the spirit and scope of the present invention.

Reference in the description to “an embodiment,” “one embodiment,” “an example embodiment,” “some embodiments,” and “various embodiments” means that a particular feature, structure, step, operation, or characteristic described in connection with the embodiment(s) is included in at least one embodiment of the invention. Further, the appearances of the phrases “an embodiment,” “one embodiment,” “an example embodiment,” “some embodiments,” and “various embodiments” in various places in the description do not necessarily all refer to the same embodiment(s).

The description includes references to the accompanying drawings, which form a part of the detailed description. The drawings show illustrations in accordance with exemplary embodiments. These embodiments, which may also be referred to herein as “examples,” are described in enough detail to enable those skilled in the art to practice the embodiments of the claimed subject matter described herein. The embodiments may be combined, other embodiments may be utilized, or structural, logical, and electrical changes may be made without departing from the scope and spirit of the claimed subject matter. It should be understood that the embodiments described herein are not intended to limit the scope of the subject matter but rather to enable one skilled in the art to practice, make, and/or use the subject matter.

In general, BLDC motors fall in the broad category of permanent magnet synchronous machines, which include a rotor made of permanent magnets and a stator housing windings made of copper coil. Unlike brushed motors which are mechanically commutated using carbon contact brushes and a commutator, brushless motors are electronically commutated, e.g., by using a microcontroller. Because of the absence of an electrical contact between the stator and the rotor, brushless motors offer several advantages over the brushed counter parts. Some of them are higher efficiency, high torque and speed, less maintenance, low noise operation, and high torque-to-weight ratio. BLDC motors can be classified as single-phase BLDC motors or three-phase BLDC motors based on the driving inputs.

In some embodiments, two main control input parameters used for controlling single-phase BLDC motors are winding voltage and commutation timing. The winding voltage along with proper commutation timing ensures optimal current flow through the windings which provides the necessary torque output. The angular velocity of the rotor is dependent on the torque produced and the dynamics of the system. Once the BLDC motor starts up in a pre-determined direction, current in the winding must be reversed at regular intervals based on the rotor angle. This process is called commutation. As the exact timing of commutation depends on the rotor angle, it is essential to feedback the rotor position by using a suitable position sensor. This may require a closed-loop operation. Hall-effect sensors are the most widely used position sensors for BLDC motors. The exact timing of commutation has a crucial impact on the performance of the motor. Various parameters such as peak torque, winding current, power consumption, vibration and noise are greatly affected by commutation timing. Some motors with a fixed speed operate on a fixed commutation timing based on the rotor position alone. However, when the system is highly dynamic, such as with varying load and varying speed, a fixed commutation timing will not yield optimal performance. Therefore, the commutation timing needs to be continuously adjusted by the firmware in the microcontroller to yield the best performance of the motor.

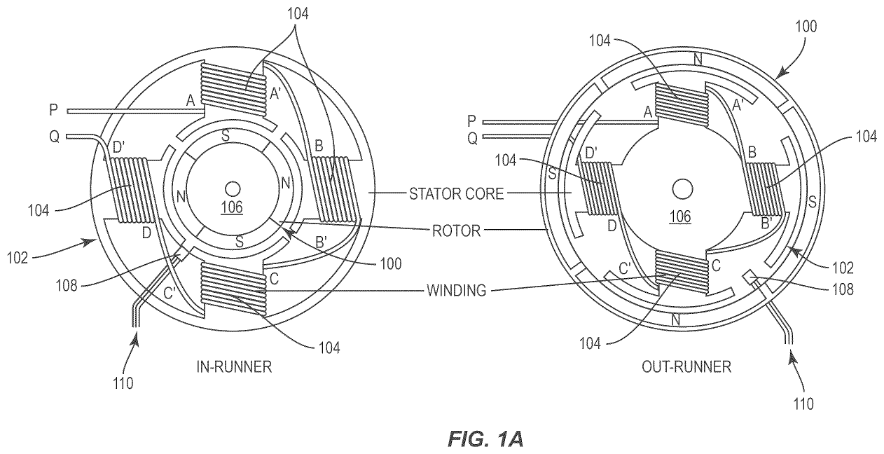

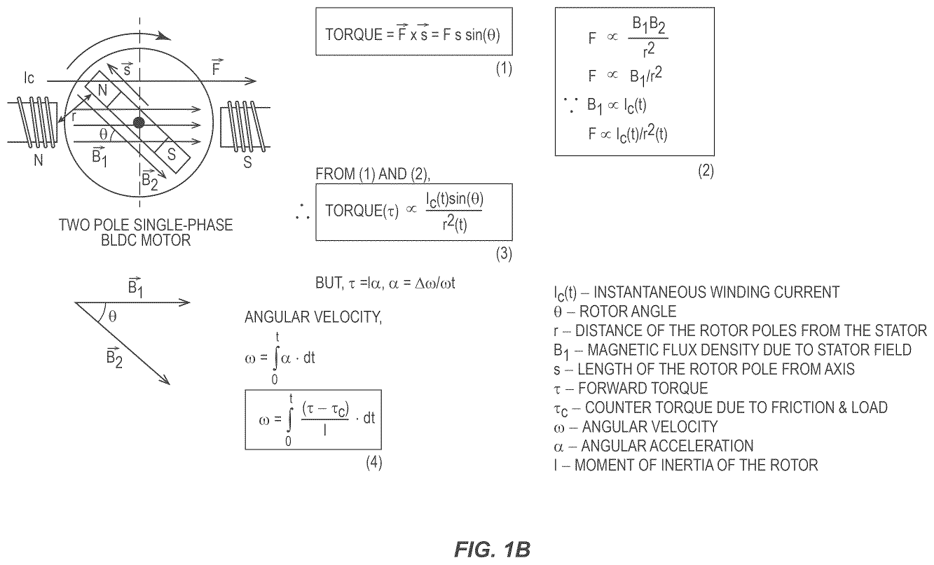

FIG. 1A illustrates the structure of a 4-pole single-phase BLDC motor. As illustrated in FIG. 1A, brushless motors are physically made up of two parts, a rotor 100 containing permanent magnetic poles (‘N’, ‘S’ in FIG. 1A) and a stator 102 housing copper windings 104. The rotor 100 can be situated either within the stator (in-runner) 102 or outside the stator (out-runner) 102. In either case, there is no direct electrical contact between the rotor 100 and the stator 102. The stator 102 includes windings 104 of copper coil connected in series and therefore the same current flows through all of them. In FIG. 1A, ‘P’ and ‘Q’ are the input terminals of the windings 104. Different windings 104 can be connected within the motor or externally to form a series connection. The adjacent slots are wound in opposite directions to ensure that adjacent windings 104 facing the rotor 102 produce electromagnetic poles with opposite polarity when energized. A steel core 106 provides increased permeability to distribute the magnetic field lines uniformly. The number of magnetic pole-pairs on the rotor 100 and the number of slots on the stator 102 also have an impact on the torque produced. In general, the more the number of magnetic poles on the rotor 100, the higher the torque produced.

FIG. 1A shows a single-phase BLDC motor with 4 rotor poles (2 pole-pairs) and 4 stator windings 104, in both in-runner and out-runner configurations. However, different combinations of numbers of stator and rotor poles can be used as per the system or application requirements. Usually, out-runner configuration produces higher torque as the rotor arm is further away from the center. Single-phase BLDC motors often use a position sensor 108 such as a Hall-effect sensor to determine the rotor position which is required for commutation. The sensor 108 is usually mounted close to the rotor 100 in a fixed location on the motor to detect the magnetic field produced by the rotor 100. The terminals 110 of the sensor 108 are brought out of the motor for external connection.

FIG. 1B illustrates a mathematical model of a simple single-phase brushless motor.

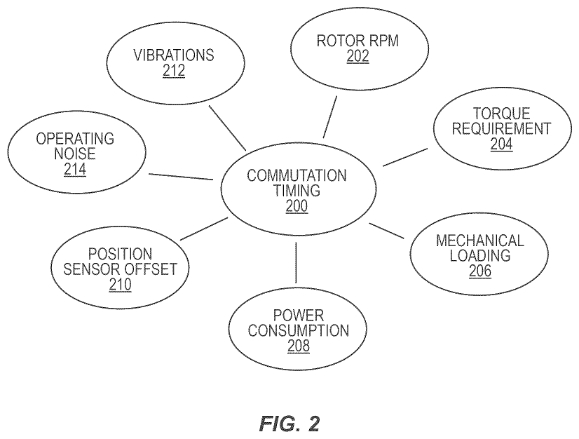

The commutation timing 200 in brushless motors (e.g., such as BLDC motors) is dependent on multiple internal and external parameters of motor operation such as RPM of the motor 202, torque requirements 204 of the particular application, mechanical loading 206, power consumption 208, placement of the position sensor 210, vibration 212, operating noise 214, etc., as illustrated in FIG. 2. The mathematical relation of commutation timing with most of these parameters is complex and difficult to calculate. External factors such as mechanical loading are dynamic in nature and therefore an adaptive tuning of the best commutation phase is essential for optimal and robust performance of the motor.

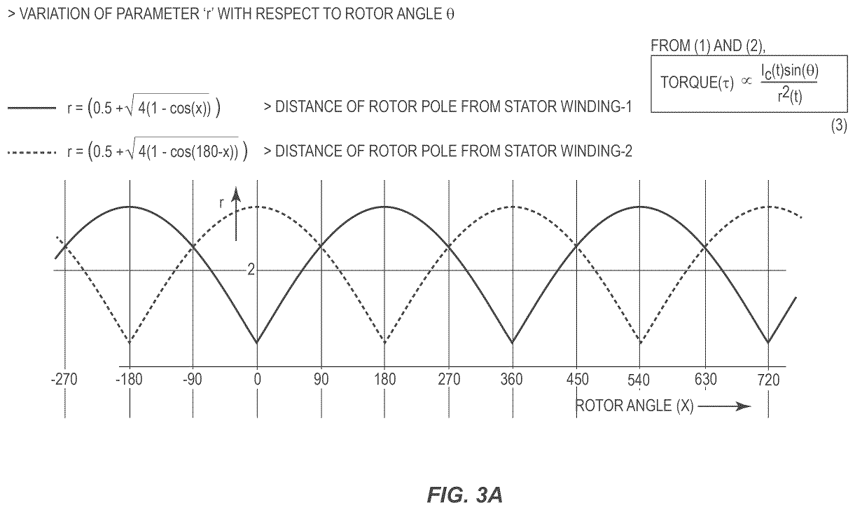

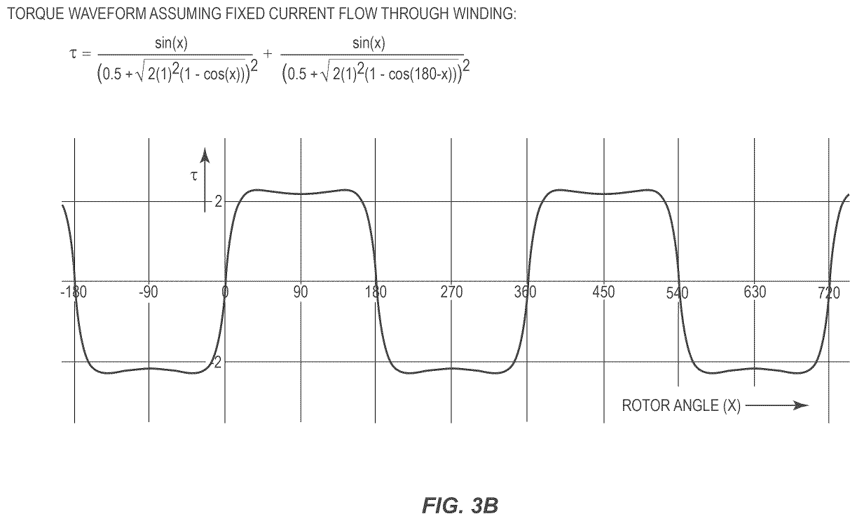

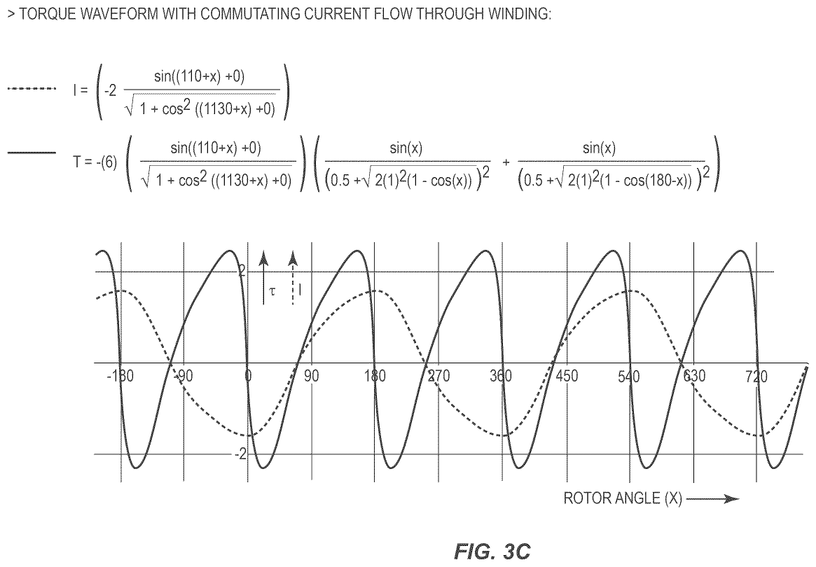

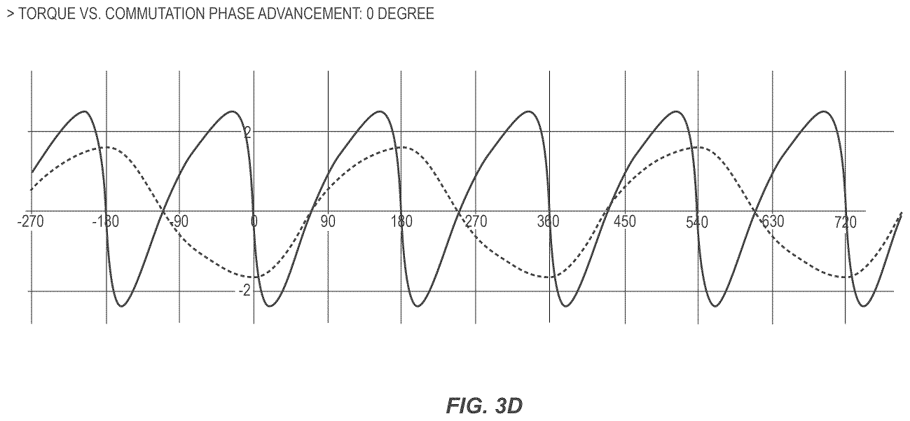

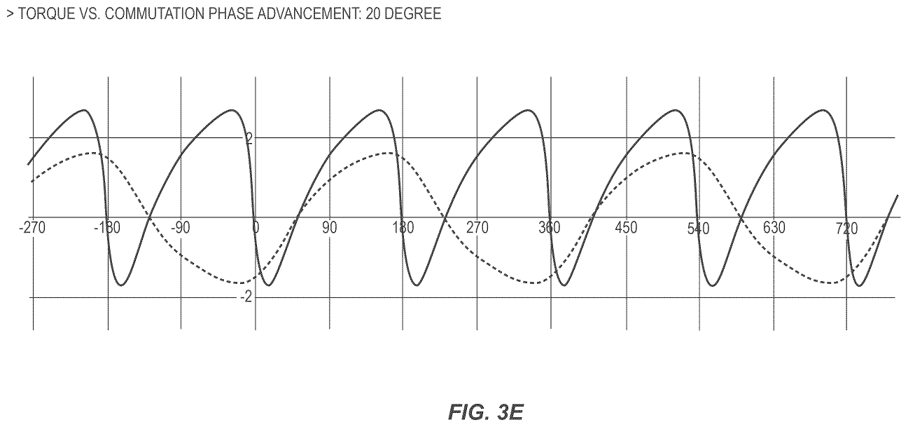

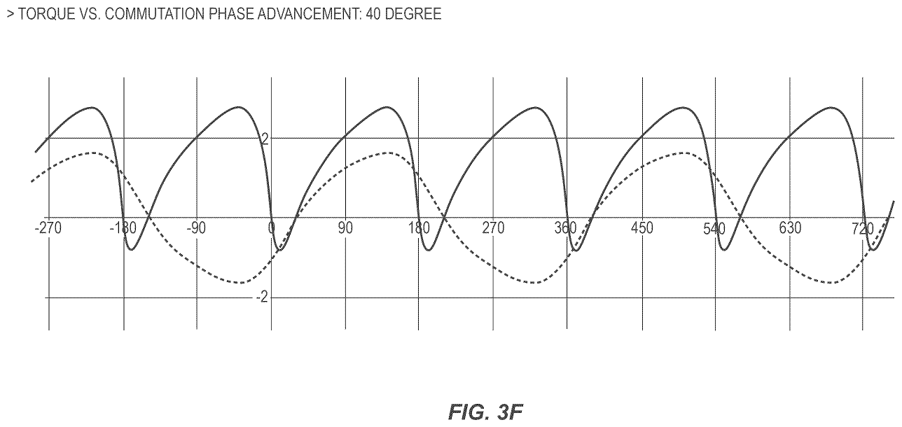

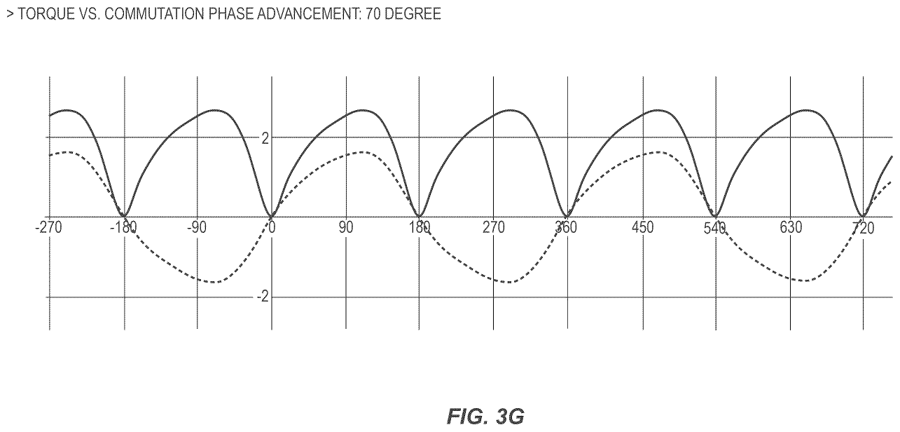

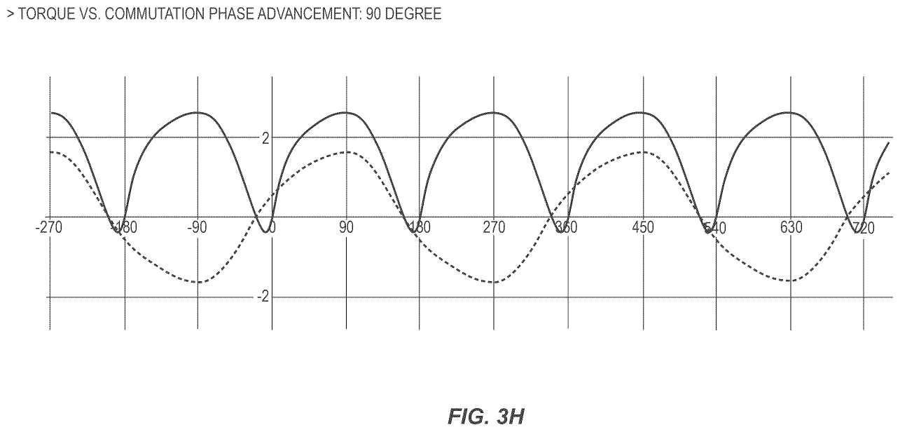

FIGS. 3A-3C illustrate the relation between torque (t) and commutation timing (I) in brushless motors (e.g., such as BLDC motors) in various embodiments. FIGS. 3D-3H illustrate the relation between torque and commutation timing in brushless motors for different degrees of phase advancement, ranging from zero degrees phase advancement (FIG. 3D) to 90° of phase advancement (FIG. 3H). The waveforms shown in FIGS. 3A-3H assume constant values for a few parameters, which are not explicitly shown in the corresponding mathematical expressions. FIGS. 3A-3H emphasize the variation in torque based on commutation phase change and RPM. In practical situations, the shapes of the waveforms and the optimal commutation angle may vary as per the system specifications.

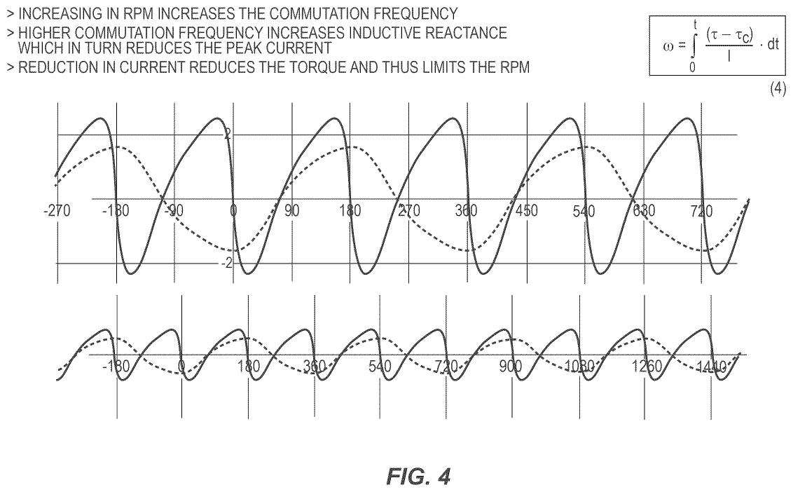

FIG. 4 illustrates the relation between angular velocity (@) and commutation timing (I) in brushless motors (e.g., such as BLDC motors) in various embodiments.

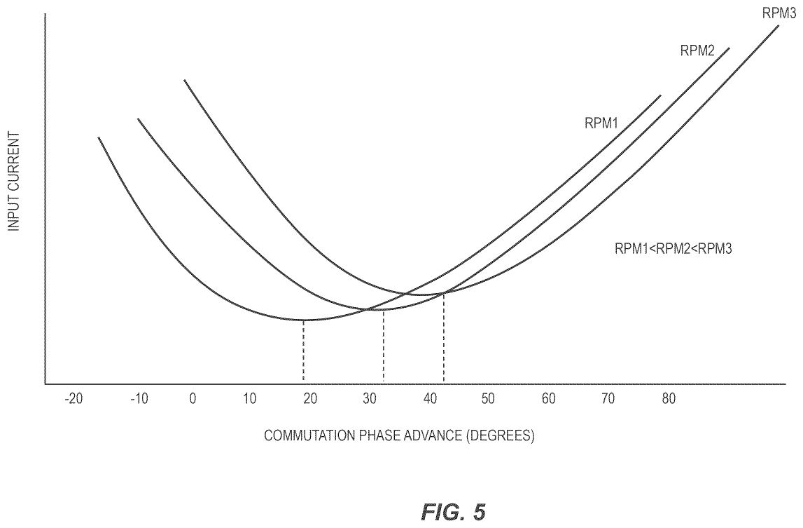

FIG. 5 illustrates the relationship between power consumption and commutation timing in brushless motors (e.g., such as BLDC motors) in various embodiments, as a function of RPM where RPM1<RPM2<RPM3.

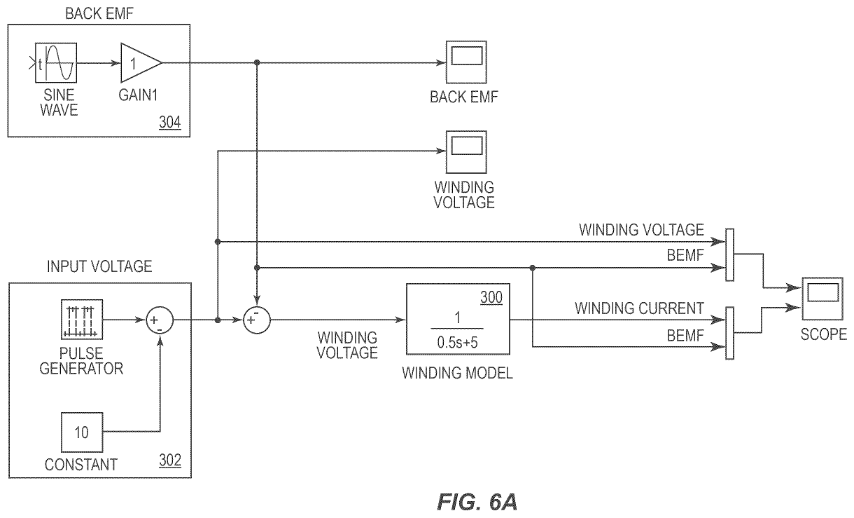

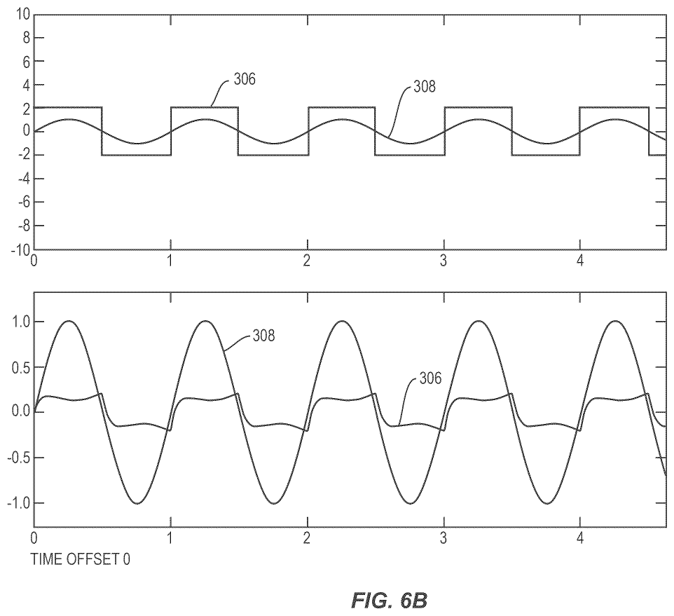

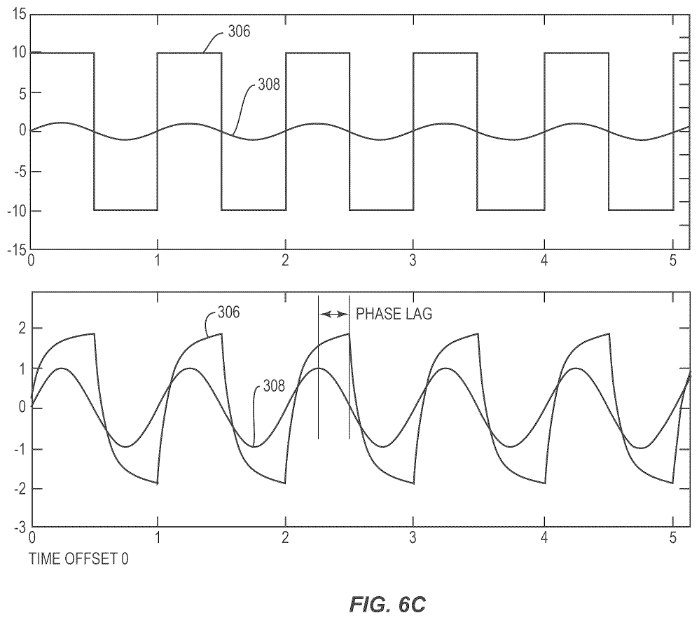

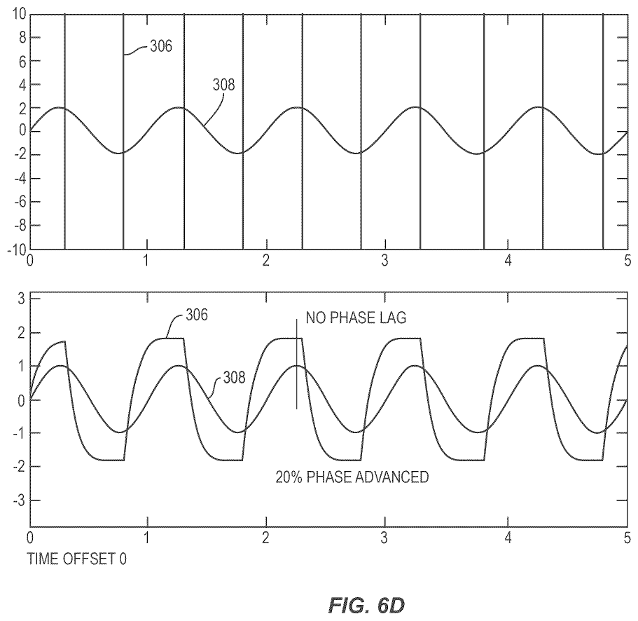

Another parameter affecting commutation phase in brushless motors is load torque. For efficient operation of BLDC motors, the lag between the peak winding current and the peak back electro-magnetic force (EMF) should be minimal. This relation can be expressed as in Equation (1) below:

$$V ( t ) = E ( t ) + I ( t ) \cdot R + L \cdot dI ( t ) / dt \qquad ( Equation 1 )$$

where E(t) is the back EMF. However, when the load torque on the rotor is increased, the winding current increases, which also increases the lag between current and back EMF. To overcome the torque deficit due to this current lag, advancing the commutation phase must be done at higher torque demand. A higher torque demand is expressed as the greater current divided by RPM (e.g., Current/RPM). FIG. 6A-6D illustrate MATLAB simulation results with respect to this relationship, where the winding voltage input to a model 300 of the windings 104 is based on the difference between a fixed input voltage 302 and the back EMF 304, and show how advancing commutation at higher torque demand increases the torque by aligning the current waveform with the back EMF.

As shown in FIG. 6B, at very low torque requirement, the current 306 is very low (e.g., 0.2 A). The current peak is almost flat and aligns with the back EMF waveform 308. As such, the current lag is minimum and hence optimum torque is produced. As shown in FIG. 6C, at very high torque requirement, the current 306 is very high (e.g., 2 A). The current peak 306 lags behind the back EMF waveform 308. Therefore, less torque is produced and current consumption is higher. This results in wasted power and the motor operating at relatively low efficiency. In FIG. 6D, which represents very high torque requirement, the commutation phase is advanced 20%. This helps the current peak 306 to align with the back EMF waveform 308. In addition, the current peak flattens, thereby increasing the RMS value which results in even more torque. Therefore, optimum torque is produced and current consumption is less compared to 0% phase advancement. In this example, input power is fully utilized and the motor operates at relatively higher efficiency.

In some embodiments of the gradient descent techniques for adaptive commutation phase tuning described herein, a controller such as a Universal Serial Bus (USB) integrated circuit (IC) controller is configured to control a single-phase BLDC motor. These embodiments allow for integration of low-cost, low-power, high-speed single-phase BLDC motor control into an end-product system or device with rich set of features and optional USB Power Delivery (USB-PD) interface, with minimal requirement of external components. For example, such systems or devices may be compliant with a specific revision and/or version of the USB-PD specification. The USB-PD specification defines a standard protocol designed to enable the maximum functionality of USB-enabled devices by providing more flexible power delivery along with data communications over a single USB-C cable through USB-C ports. The USB-PD specification also describes the architecture, protocols, power supply behavior, parameters, and cabling necessary for managing power delivery over USB-C cables at up to 100 W of power (or higher, up to 240 W, in case of Extended Power Range, or EPR). According to the USB-PD specification, devices with USB-C ports may negotiate for more current and/or higher or lower voltages over a USB-C cable than are allowed in older USB specifications (e.g., such as the USB 2.0 Specification, the USB Battery Charging Specification Rev. 1.1/1.2, etc.). For example, the USB-PD specification defines the requirements for a power delivery contract (PD contract) that can be negotiated between a pair of USB-PD enabled devices. The PD contract can specify both the power level and the direction of power transfer that can be accommodated by both devices, and can be dynamically re-negotiated (e.g., without device un-plugging) upon request by either device and/or in response to various events and conditions, such as power role swap, data role swap, hard reset, failure of the power source, etc.

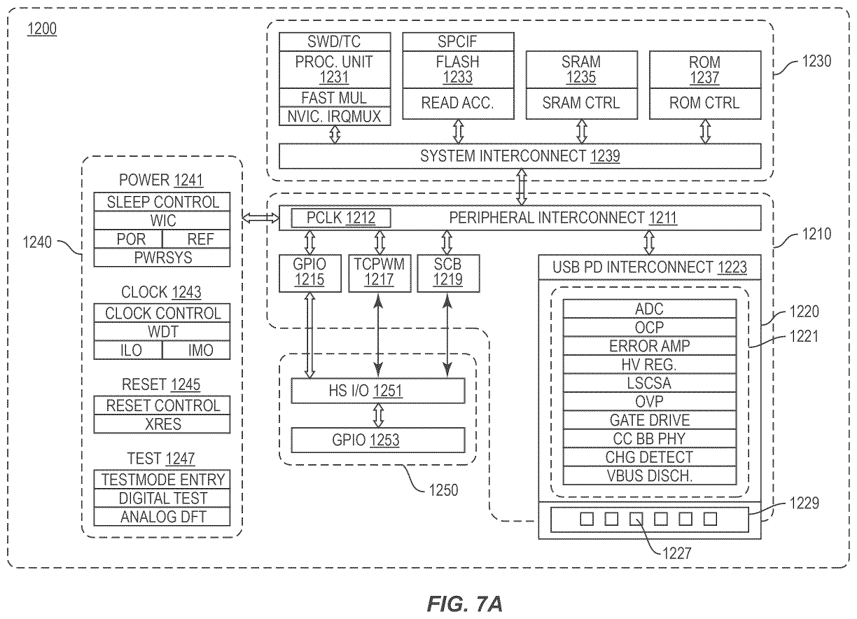

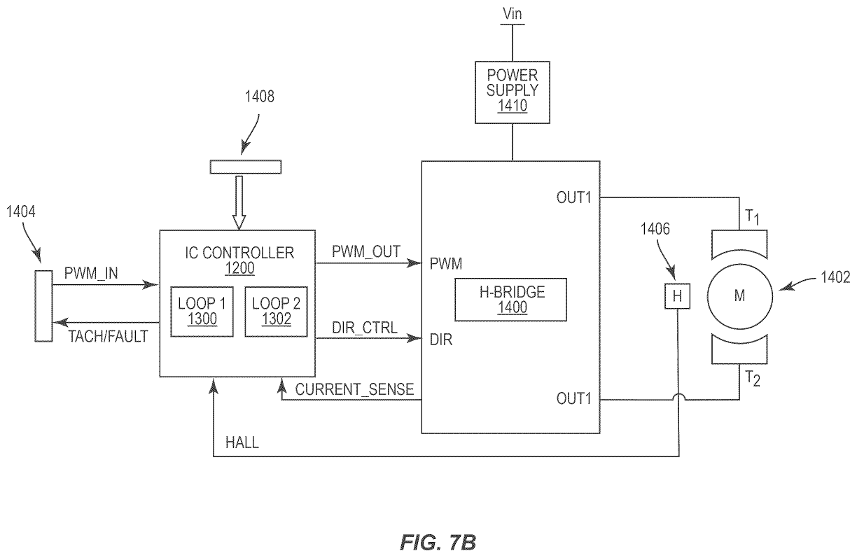

FIG. 7A is a block diagram illustrating a USB-PD IC controller 1200 that can be configured as BLDC motor controller in accordance with some embodiments of the gradient descent technique described herein. IC controller 1200, also referred to herein as controller, may include a peripheral subsystem 1210 including components for use in USB-PD power delivery. Peripheral subsystem 1210 may include a peripheral interconnect 1211 including a clocking module, peripheral clock (PCLK) 1212 for providing clock signals to the various components of peripheral subsystem 1210. Peripheral interconnect 1211 may be a peripheral bus, such as a single-level or multi-level advanced high-performance bus (AHB), and may provide data and control interface between peripheral subsystem 1210, CPU subsystem 1230, and system resources 1240. Peripheral interconnect 1211 may include controller circuits, such as direct memory access (DMA) controllers, which may be programmed to transfer data between peripheral blocks without input by, control of, or burden on CPU subsystem 1230.

The peripheral interconnect 1211 may be used to couple components of peripheral subsystem 1210 to other components of IC controller 1200. Coupled to peripheral interconnect 1211 may be a number of general purpose input/outputs (GPIOs) 1215 for sending and receiving signals. GPIOs 1215 may include circuits configured to implement various functions such as pull-up, pull-down, input threshold select, input and output buffer enabling/disable, single multiplexing, etc. Still other functions may be implemented by GPIOs 1215. One or more timer/counter/pulse-width modulator (TCPWM) 1217 may also be coupled to the peripheral interconnect and include circuitry for implementing timing circuits (timers), counters, pulse-width modulators (PWMs) decoders, and other digital functions that may operate on I/O signals and provide digital signals to system components of IC controller 1200. Peripheral subsystem 1210 may also include one or more serial communication blocks (SCBs) 1219 for implementation of serial communication interfaces such as inter-integrated circuit (I2C), serial peripheral interface (SPI), universal asynchronous receiver/transmitter (UART), controller area network (CAN), clock extension peripheral interface (CXPI), etc. GPIO 1215, TCPWM 1217, and SCB 1219 may be coupled to an input/output (I/O) subsystem 1250, which may include a high-speed (HS) I/O matrix 1251 coupled to a number of GPIOs 1253. GPIOs 1215, TCPWM 1217, and SCB 1219 may be coupled to GPIOs 1253 through HS I/O matrix 1251.

Peripheral subsystem 1210 may include a USB power delivery subsystem 1220 coupled to the peripheral interconnect and comprising a set of USB-PD modules 1221 for use in USB power delivery. USB-PD modules 1221 may be coupled to the peripheral interconnect 1211 through a USB-PD interconnect 1223. USB-PD modules 1221 may include an analog-to-digital conversion (ADC) module for converting various analog signals to digital signals; an error amplifier (AMP) regulating the output voltage on VBUS line per a PD contract; a high-voltage (HV) regulator for converting the power source voltage to a precise voltage (such as 3.5-5V) to power IC controller 1200; a high-side or low-side current sense amplifier (e.g., LSCSA) for measuring load current accurately; an over voltage protection (OVP) module and an over-current protection (OCP) module for providing over-current and over-voltage protection on the VBUS line; and a communication channel PHY (CC BB PHY) module for supporting communications on a USB-C communication channel (CC) line. USB-PD modules 1221 may also include a charger detection module for determining that a charging circuit is present and coupled to IC controller 1200 and a VBUS discharge module for controlling discharge of voltage on VBUS. The discharge control module may be configured to couple to a power source node on the VBUS line or to an output (power sink) node on the VBUS line and to discharge the voltage on the VBUS line to the desired voltage level (i.e., the voltage level negotiated in the PD contract). USB power delivery subsystem 1220 may also include pads 1227 for external connections and electrostatic discharge (ESD) protection circuitry 1229, which may be required on a Type-C (USB-C) port.

IC controller 1200 may also include a number of system resources 1240, including a power module 1241, a clock module 1243, a reset module 1245, and a test module 1247. Power module 1241 may include a sleep control module, a wake-up interrupt control (WIC) module, a power-on-reset (POR) module, a number of voltage references (REF), and a PWRSYS module. In some embodiments, power module 1241 may include circuits that allow IC controller 1200 to draw and/or provide power from/to external sources at different voltage and/or current levels and to support controller operation in different power states, such as active, low-power, or sleep. In various embodiments, more power states may be implemented as IC controller 1200 throttles back operation to achieve a desired power consumption or output. Clock module 1243 may include a clock control module, a watchdog timer (WDT), an internal low-speed oscillator (ILO), and an internal main oscillator (IMO). Reset module 1245 may include a reset control module and an external reset (XRES) module. Test module 1247 may include a module to control and enter a test mode as well as testing control modules for analog and digital functions (digital test and analog DFT).

IC controller 1200 may also include a central processing unit (CPU) subsystem 1230 for processing commands and storing firmware, program information and data. CPU subsystem 1230 may include one or more processing units 1231 for executing instructions and reading from and writing to memory locations from a number of memories. Processing unit 1231 may be a processor suitable for operation in an integrated circuit (IC) or a system-on-chip (SOC) device. In some embodiments, processing unit 1231 may be optimized for low-power operation with extensive clock gating. In this embodiment, various internal control circuits may be implemented for processing unit operation in various power states. For example, processing unit 1231 may include a wake-up interrupt controller (WIC) configured to wake the processing unit up from a sleep state, allowing power to be switched off when the IC or SOC is in a sleep state. CPU subsystem 1230 may include one or more memories, including flash memory 1233, static random access memory (SRAM) 1235, and read-only memory (ROM) 1237. Flash memory 1233 may be a non-volatile memory (NAND flash, NOR flash, etc.) configured for storing data, programs, and/or other firmware instructions. Flash memory 1233 may include a read accelerator and may improve access times by integration within CPU subsystem 1230. SRAM 1235 may be a volatile memory configured for storing data and firmware instructions accessible by processing unit 1231. ROM 1237 may be configured to store boot-up routines, configuration parameters, and other firmware parameters and settings that do not change during operation of IC controller 1200. SRAM 1235 and ROM 1237 may have associated control circuits. Processing unit 1231 and the memories may be coupled to a system interconnect 1239 to route signals to and from the various components of CPU subsystem 1230 to other blocks or modules of IC controller 1200. System interconnect 1239 may be implemented as a system bus such as a single-level or multi-level AHB. System interconnect 1239 may be configured as an interface to couple the various components of CPU subsystem 1230 to each other. System interconnect 1239 may be coupled to peripheral interconnect 1211 to provide signal paths between the components of CPU subsystem 1230 and peripheral subsystem 1210.

In accordance with the gradient descent techniques for adaptive commutation phase tuning described herein, GPIOs 1215, TCPWM 1217, and/or LSCSA and ADC of IC controller 1200 may be coupled to an external IC controller or another discrete device (e.g., such as a bridge or driver) to provide commutation control for a BLDC motor, where the CSA may be within IC controller 1200 or externally interfaced. For example, firmware and/or other program logic may be executed by CPU subsystem 1230 to provide output control PWM signals based on input current sense signals and/or sensor signals, received from an external controller or device, that represent information feedback regarding the operation of the BLDC motor.

FIG. 7B is a block diagram of a system for control of a BLDC motor in accordance with various embodiments of the present disclosure. In FIG. 7B, an H-bridge device 1400 is coupled to GPIOs 1215, TCPWM 1217, and/or LSCSA and ADC of IC controller 1200 to provide commutation control for a single-phase BLDC motor (“M”) 1402. The H-bridge device 1400 includes H-bridge MOSFETs with NFET gate drivers to achieve commutation in the BLDC motor 1402. A digital input pin of the H-bridge device 1400 is coupled to a GPIO pin of the IC controller 1200, to invert the direction of current flow through the motor windings by switching on/off appropriate MOSFETs in the H-bridge device 1400. The H-bridge device 1400 has a single PWM input ‘PWM’ from the IC controller 1200 to control the H-bridge MOSFETs. A host connector 1404 provides a reference speed signal (PWM_IN) from a host (not shown in FIG. 7B) to the IC controller 1200, to dynamically control the RPM of the motor 1402. A feedback signal ‘TACH/FAULT’ provided to the host connector 1404 indicates the RPM of the motor 1402 to the host. The IC controller 1200 can indicate a fault in the system by pulling the TACH/FAULT line low. The IC controller 1200 controls the H-bridge device 1400, e.g., by driving control signals such as PWM_OUT and DIR_CTRL based on the feedback signals from a Hall-effect sensor 1406 and live current measurements using the LSCSA and ADC which may be integrated in the IC controller 1200, for example. The terminals T₁ and T₂ of the single-phase BLDC motor 1402 are connected to ‘OUT1’ and ‘OUT2’ pins of the H-bridge device 1400. A programming interface 1408 provides a programming interface to program the IC controller 1200 with the necessary firmware and/or other program logic. The Hall-effect sensor 1406 or similar type of sensor is used to provide feedback signals (‘HALL’ in FIG. 7B) to the IC controller 1200, for determining the rotor position which is used for commutation. The frequency of the Hall feedback signal also may be used to calculate the rotor RPM.

When the system of FIG. 7B operates in closed-loop control operation, it is expected that the motor RPM dynamically tracks the reference RPM input as closely as possible. An analog voltage input corresponding to the reference RPM is fed to the control system operated in the IC controller 1200. However, in other embodiments generating a digital signal for this purpose is easily feasible for an embedded host controller. The commutation in the system of FIG. 7B is handled by the IC controller 1200 in a closed-loop control by monitoring the feedback signal from the Hall-effect sensor 1406. The exact time to commutate the motor 1402 is dependent on multiple factors such as Hall sensor placement (e.g., on a printed circuit board, or PCB), RPM, load torque, etc., e.g., as illustrated in FIG. 2. The commutation timing also greatly affects operation parameters such as torque production and power consumption of the motor, e.g., as illustrated in FIGS. 3A-6D.

Generally, it is advantageous to vary the commutation timing dynamically based on these factors as discussed heretofore. The input signal to the H-bridge device 1400 controls the commutation by switching the appropriate MOSFETs in the H-bridge device 1400. For example, the DIR_CTRL signal is a digital output signal from the IC controller 1200 whose logic level decides which of the (e.g., four) MOSFETs in the H-bridge device 1400 are in the on state at any instant. The DIR_CTRL signal is configured to closely follow the Hall sensor feedback signal through firmware control. To advance the commutation, the phase difference between the DIR_CTRL and Hall signals is altered by providing the necessary phase advancement to the DIR_CTRL signal, in accordance with the gradient descent technique described herein.

The Hall sensor 1406 may be placed at the slot between two stator windings of the BLDC motor 1402. This normally ensures that when a permanent magnetic rotor pole crosses the point, the Hall signal toggles its value. This also corresponds to the instant when the rotor poles align with the stator windings, which is ideally suited for commutation. In another example, some fixed RPM-based designs, which use fixed commutation timing, may place the Hall sensor 1406 with some offset with respect to the stator winding. However, leading to the present disclosure, it was discovered that the placement of the Hall sensor 1406 is significant to achieving proper commutation timing in BLDC motors. Specifically, observed inaccurate commutation timing was determined to be due to an offset of the Hall sensor IC placement on the PCB, which critically affected the performance of the motor. It was then experimentally confirmed that RPM-based commutation advancement yielded different and unexpected performance in different BLDC motor set-ups, due to small offsets (<10 deg) in Hall sensor IC position, which may be due to various manufacturing issues such as minor soldering offset or PCB assembly issue.

To address the above issue with Hall sensor placement as well as other performance issues, the gradient descent technique described herein uses a variable commutation timing to yield optimal performance in different operating conditions. In this regard, an early commutation before the rotor pole aligns with the stator is termed as commutation advancing. Similarly, a delayed commutation which occurs after the rotor pole crosses the stator is termed as commutation retarding. Thus, embodiments of the gradient descent technique described herein implement a variable commutation advancement based on the operating conditions, using a predictive approach. The variable commutation advancement is also referred to herein as commutation phase adjustment or adjusting the commutation phase.

In some embodiments, in order to account for unpredictable scenarios related to unintended manufacturing offsets in the placement of the Hall sensor 1406 in the hardware PCB, firmware-based adaptive control is used to dynamically optimize the commutation phase (ϕ) by measuring the current consumption. The firmware uses a gradient descent approach to find the commutation phase advancement corresponding to the lowest current.

Still referring to FIG. 7B, the motor 1402 is powered by a power supply 1410 having a fixed input voltage Vin. The controller 1200 includes a first control loop 1300 that adjusts the duty cycle of the signal PWM_OUT used to commutate current in the stator windings based on a difference between a measured variable and a reference value, such that the measured variable tracks the reference value. The controller 1200 also includes a second control loop 1302. The second control loop 1302 is adaptive in that the second control loop 1302 dynamically adjusts the commutation phase ϕ of the current in the stator windings of the motor 1402, such that the commutation phase settles at a value that corresponds to a minimum input current of the power supply Vin. This approach fully utilizes input power and the motor 1402 operates at relatively high efficiency.

In one embodiment, the measured variable is the measured speed of the rotor, e.g., as measured by the Hall sensor 1406, and the reference value is a reference speed. According to this embodiment, the first control loop 1300 is faster than the adaptive control loop 1302 such that the measured speed tracks the reference speed despite changes made to the commutation phase by the adaptive control loop 1302. Separately or in combination, the adaptive control loop 1302 dynamically adjusts the commutation phase with respect to a feedback signal ‘CURRENT_SENSE’ used to generate the measured speed of the rotor.

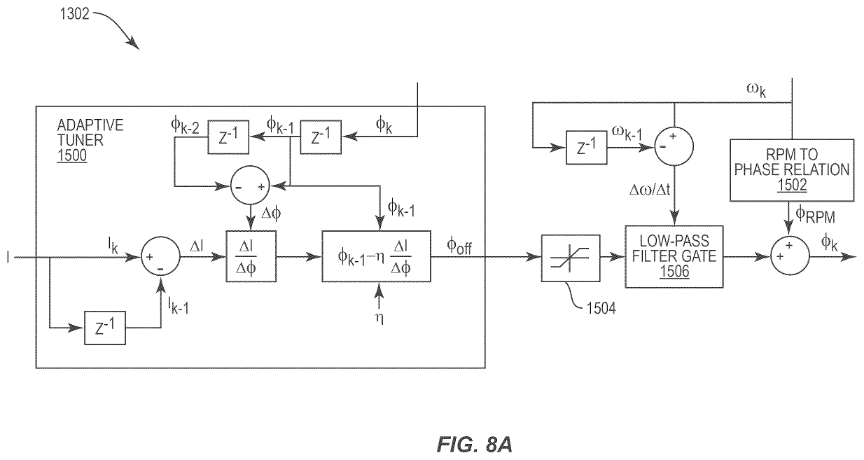

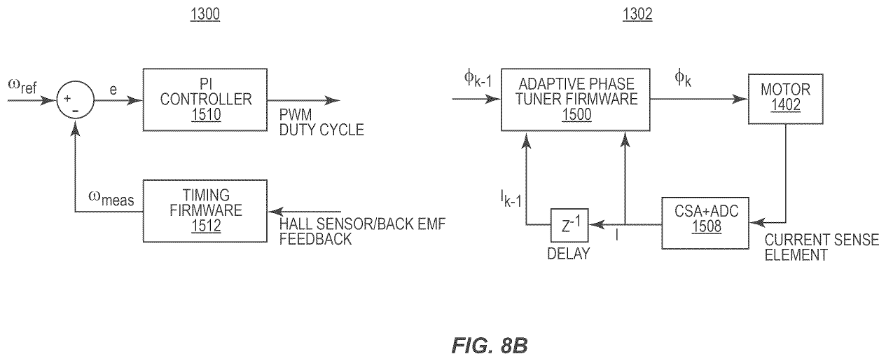

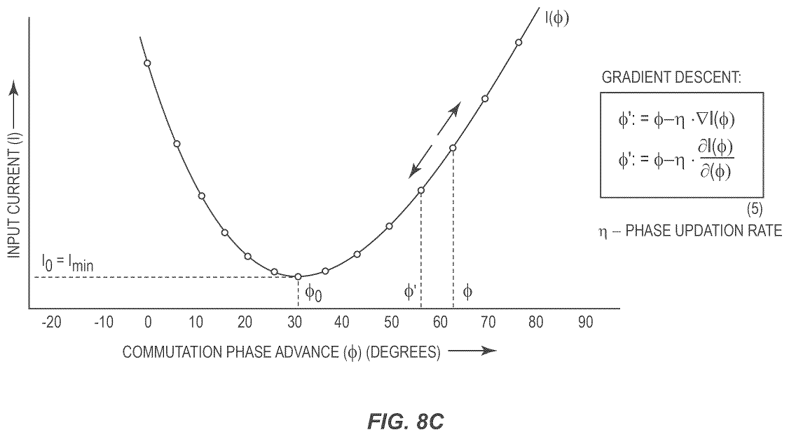

An example control block diagram using the gradient descent technique is illustrated in FIG. 8A. A more general current-sense based adaptive control system is illustrated in FIG. 8B. A graph illustrating adaptive commutation phase tuning in accordance with the gradient descent technique described herein is illustrated in FIG. 8C.

As shown in FIG. 8A, the adaptive control loop 1302 may include an adaptive tuner 1500 that adjusts the commutation phase ϕ using an iterative gradient descent algorithm. For iteration n of the iterative gradient descent algorithm, the adaptive tuner 1500 of the adaptive control loop 1302 compares a measured value Iₖ of the input current I for iteration n to a measured value Iₖ₋₁ of the input current I for iteration n−1 of the iterative gradient descent algorithm, to generate a current delta ΔI. The adaptive tuner 1500 compares a value ϕₖ₋₁ of the commutation phase ϕ for iteration n−1 to a value ϕₖ₋₂ of the commutation phase for iteration n−2 of the iterative gradient descent algorithm, to generate a commutation phase delta Δϕ. The adaptive tuner 1500 divides the current delta ΔI by the commutation phase delta Δϕ, to generate a commutation phase adjustment slope ΔI/Δϕ. The adaptive tuner 1500 scales the commutation phase adjustment slope ΔI/Δϕ by a phase update rate η and subtracts the scaled commutation phase adjustment slope η(ΔI/Δϕ) from the value ϕₖ₋₁ of the commutation phase for the iteration n−1, to generate a commutation phase offset ϕ_{off} for iteration n of the iterative gradient descent algorithm.

In one embodiment, the phase update rate η is fixed. In another, the phase update rate η is adjustable. In the case of an adjustable phase update rate η, the phase update rate η may be adjusted based on a degree of change in the commutation phase ϕ for succeeding iterations of the iterative gradient descent algorithm. For example, the controller 1200 may decrease the phase update rate η as the difference between measured values of the input current I decreases for succeeding iterations of the iterative gradient descent algorithm. This allows for learning to occur over time, to determine an optimal size of each adjustment. For example, the phase update rate η may start out larger and settle to a smaller value.

Still referring to FIG. 8A, the adaptive control loop 1302 of the controller 1200 may perform further adjusts to the commutation phase ϕ based on speed of the rotor. That is, the adaptive control loop 1302 may further adjust the commutation phase ϕ as the motor speed changes, which tends to have an almost linearly relationship. The adaptive control loop 1302 calculates a speed change rate Δω/Δt based on the difference between the rotor speed ok measured for the present iteration and the rotor speed ωₖ₋₁ measured for the previous iteration. A saturation block 1504 limits the maximum permitted commutation phase offset and a low-pass filter gate 1506 prevents adaptive tuning of the commutation phase ϕ during acceleration or deceleration of the BLDC motor 1402. The adaptive control loop 1302 translates 1502 motor RPM to a phase relationship to add an rpm-based adjustment ϕ_{RPM} to the final commutation phase adjustment determination, so that the commutation phase adjustment is also based on motor speed.

FIG. 8B shows a simplified view of the first control loop 1300 and the adaptive control loop 1302, with emphasis on the respective feedback paths to the control loops 1300, 1302. In this example, motor torque is translated into a current measurement I, e.g., by current sense amplifier (CSA) and analog-to-digital converter (ADC) circuitry 1508. The measured value Iₖ of the input current I for iteration n is then compared to the measured value Iₖ₋₁ of the input current I for iteration n−1 of the iterative gradient descent algorithm, as explained above in connection with FIG. 1B. The adaptive control loop 1302 adjusts the commutation phase ϕ such that current is minimized while the first control loop 1300 maintains fixed motor speed.

The first control loop 1300 includes a PI (proportional-integral) controller 1510 in FIG. 8B, for performing the action of mapping torque maximization problem into current minimization problem (as current is easily measurable). Timing firmware 1512 generates measures motor speed ωₘₑₐₛ based on the Hall sensor or back EMF feedback. The PI controller 1510 maintains a target rpm by adjusting the PWM duty cycle of the H-bridge 1400, based on the difference between the measured motor speed ωₘₑₐₛ and a target or reference motor speed ω_{mref}, where motor torque corresponds to winding voltage which corresponds to winding current which corresponds to PWM duty cycle. The PI controller 1510 adjusts the winding voltage based on the error signal ‘e’. No current feedback is needed by the PI controller 1510.

Whenever there is a different operating condition in the motor 1402, the controller 1200 adaptively selects/tunes the optimum commutation phase ϕ so that the lowest power consumption occurs for a particular motor speed. As shown in FIG. 8C, for any constant RPM value, the motor 1402 draws more current unless the commutation phase angle ϕ is at optimum. The iterative gradient descent algorithm implemented by the controller 1200 dynamically adjusts the commutation phase ϕ of the current in the stator windings of the motor, such that the commutation phase ϕ settles at a value Io that corresponds to the minimum input current Imin of the power supply 1410.

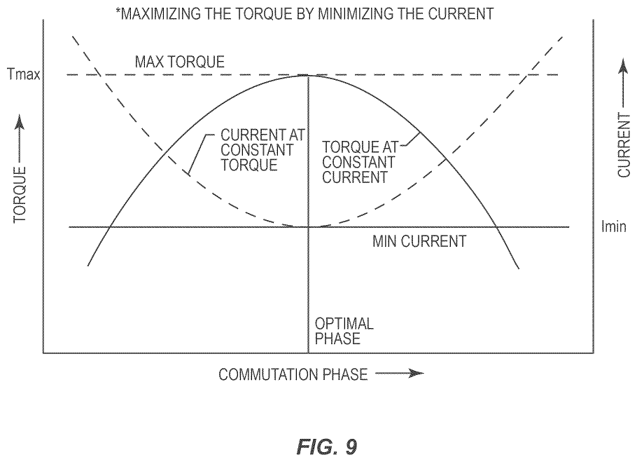

The ultimate purpose of the control system is to maximise the torque output with minimum input power. However, torque is difficult to be measured when the rotor shaft is in continuous rotation. Therefore, the first control loop 1300 may be implemented as a PI control loop that performs the action of mapping torque maximization problem into current minimization problem (as current is easily measurable). If the adaptive control system were to be made independent, then changing the commutation phase changes the motor torque and hence the speed. However, it is expected to keep the torque and speed constant. Thus, the PI (first) control loop 1300 helps to keep the torque constant while minimizing the current requirement. FIG. 9 illustrates an example operational graph of the mutual dependence of the PI and adaptive control loops 1300, 1302 for the adaptive commutation phase control block illustrated in FIGS. 8A-8C.

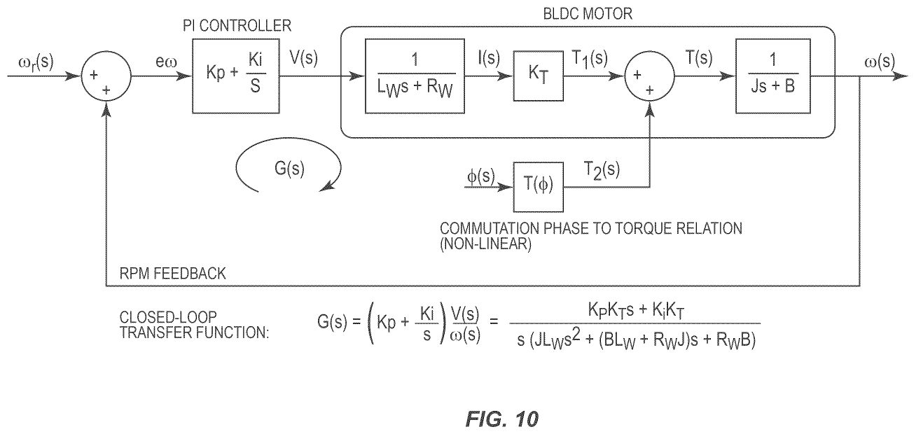

FIG. 10 illustrates a block diagram of system modeling and stability overview of a system implementing the gradient descent technique described herein. With respect to the system in FIG. 10, the closed-loop transfer function G(s) indicates clearly that location of the closed-loop poles of the system and hence the stability is determined by the values of system parameters such as the motor winding inductance (L), resistance (R), moment of inertia (J), damping coefficient (B) and the PI control loop gains (Kp and Ki). The overall stability of the system is governed by the stability of the PI (first) control loop 1300, as the bandwidth of operation of adaptive commutation phase tuning implemented by the adaptive control loop 1302 is very low comparatively (<1/1000 times) as compared to the motor speed control implemented by the first control loop 1300. This is because the adaptive phase tuning interval is expected to be close to the rise-time of the current I with respect to a step change in commutation phase ϕ, which is roughly greater than 500 ms (but may be system dependent). However, the PI (first) control loop 1300 operates at an interval of 1-10 ms. As the bandwidth of operation of the adaptive control loop 1302 is very low, it acts like a low-pass filter and hence is not affected much by the sudden changes due to high-frequency PI (first) control loop 1300. Additionally, digital filtering can be done to prevent adaptive tuning when the motor is accelerating/decelerating, e.g., as shown in FIG. 8A by low-pass filter gate 1506.

In FIG. 10, T(s) is the total torque required to maintain a speed of the rotor at a specific load condition. T(s) is the sum of T₁(s) output by the first control loop 1300 and T₂(s) output by the adaptive control loop 1302. The adaptive control loop 1302 adjusts T₂(s) based on a value of the commutation phase value ϕ(s). The first control loop 1300 adjusts T₁(s) as T₁(s)=T(s)−T₂(s), such that any change in T₂(s) due to commutation phase change is complimented by T₁(s) and the total torque T(s) remains constant in steady state. As such, the first control loop 1300 maintains constant rotor speed irrespective of load conditions and commutation phase adjustments.

The gradient descent technique for adaptive commutation phase tuning described herein provides several advantages over conventional solutions for commutation control of brushless motors (e.g., such as BLDC motors). For example, by deploying adaptive tuning control, complex mathematical dependencies on the various motor operation parameters, which can be hard-coded in the controller firmware, are simplified to yield better motor performance. The first (e.g., PI) control loop 1300 and the adaptive control loop 1302 described herein complement each other to meet the respective objectives of each. Power consumption of the motor 1402 is optimized to the lowest possible level, but while still maintaining the desired performance such as torque and speed. The controller 1200 provides robustness to mechanical load variations and supply voltage changes. The effect of physical offset in the Hall sensor IC placement on a PCB is nullified as the commutation phase tuning is dynamic, thereby providing robustness regardless of manufacturing tolerances.

In some embodiments, during closed-loop speed control, when the rotor of the BLDC motor 1402 is subjected to an external counter-torque due to loading, the current consumption of the motor 1402 increases. Due to the behavior of the coil inductance, the shape of the winding current waveform is also altered. This results in the current waveform lagging behind the back EMF waveform, which results in torque reduction. Therefore, while running at higher load, it is expected to advance the commutation. The gradient descent technique described herein helps to dynamically tune the commutation phase to an optimal value to yield higher torque production. When the motor 1402 operates in closed-loop speed control, any deviation in the commutation phase from the optimal value will not reduce the torque and speed of the motor. But instead, the controller 1200 increases the current and power consumption to maintain the desired speed, which leads to power loss in the system. Therefore, the gradient descent technique described herein provides for measuring the current regularly and minimizes the current by continuously tuning the commutation phase ϕ, thereby reducing the power loss and improving the efficiency of the system.

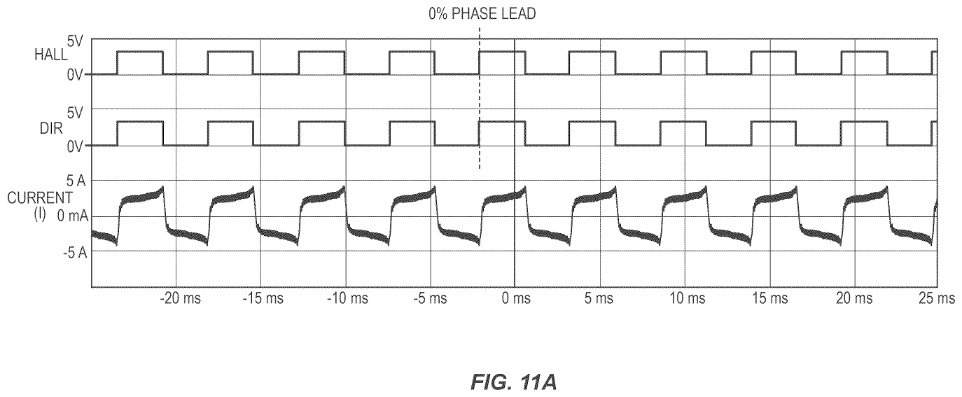

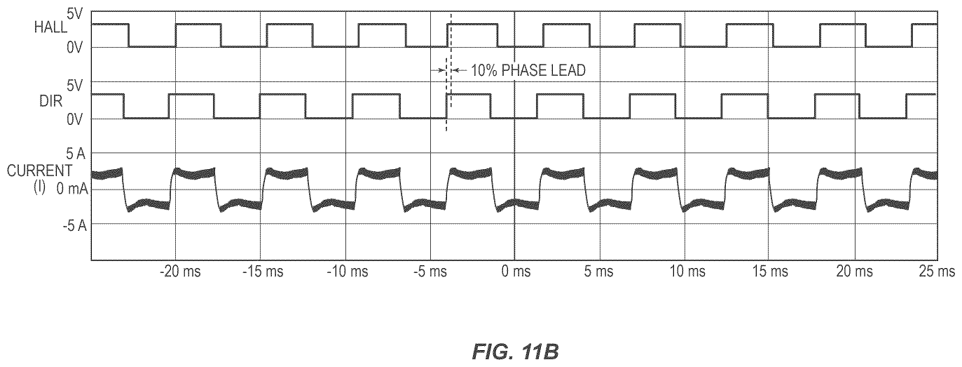

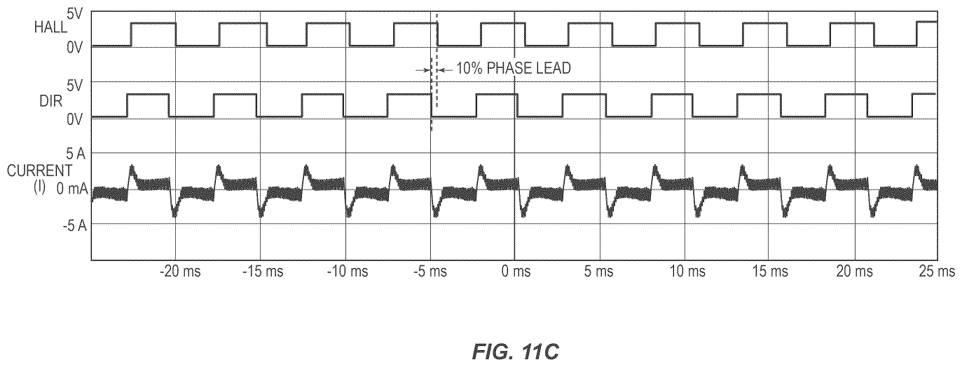

FIGS. 11A and 11B illustrate the effect of commutation phase advancement on a loaded rotor of a BLDC motor based on experimental data. In this example, the motor runs at fixed 5500 RPM and the rotor is subjected to a fixed load. As evident from FIGS. 11A and 11B, current (I) consumption (RMS value) is lower by around 500 mA when the commutation phase ϕ is advanced by 10%. However, when the rotor is unloaded, the commutation phase of 10% is greater than the optimal value. This is shown by the current peak shifting towards the left in FIG. 11C, which is undesirable. Therefore, any variation in the external load demands a change in the commutation phase ϕ.

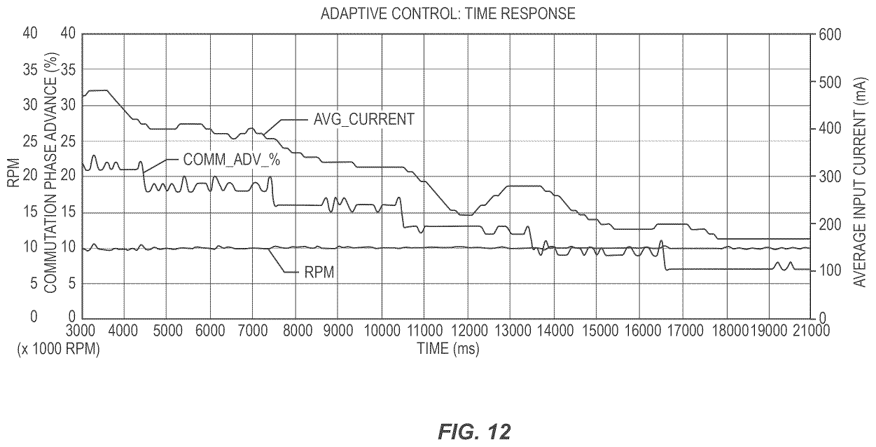

FIG. 12 shows the real-time response of the adaptive control captured during run-time in accordance with an example embodiment. Specifically, FIG. 12 shows that the commutation phase advancement value (‘comm_adv_%)’ is adjusted dynamically to tune the motor to consume the lowest average current (avg_current) and thereby the lowest power, for a particular RPM (e.g., 10000 RPM, as illustrated). This feature provides control robustness to operate optimally during load variations and Hall-effect sensor offsets.

The described herein gradient descent technique for adaptive commutation phase tuning in BLDC motors can be used in a variety of applications. In general, BLDC motor applications are gaining popularity in the electronic market due to their numerous advantages in comparison to the conventional alternating current (AC) induction motors and brushed DC motors. Single-phase BLDC motors are simple and require simpler hardware for operation. They are often used as cooling fans and pumps, for example in micropumps for liquid cooling of GPUs in datacenters. Thus, there is a great potential of single-phase BLDC motors to replace the existing brushed DC motors directly as the input voltage source is same as that of a brushed DC motor. They are most suitable to be used in low-power electronic gadgets and cooling systems. Therefore, considering the energy efficiency factor in BLDC motors, controllability, and the rapid growth in the field of embedded electronics, there is a market tendency to shift to the usage of BLDC motors.

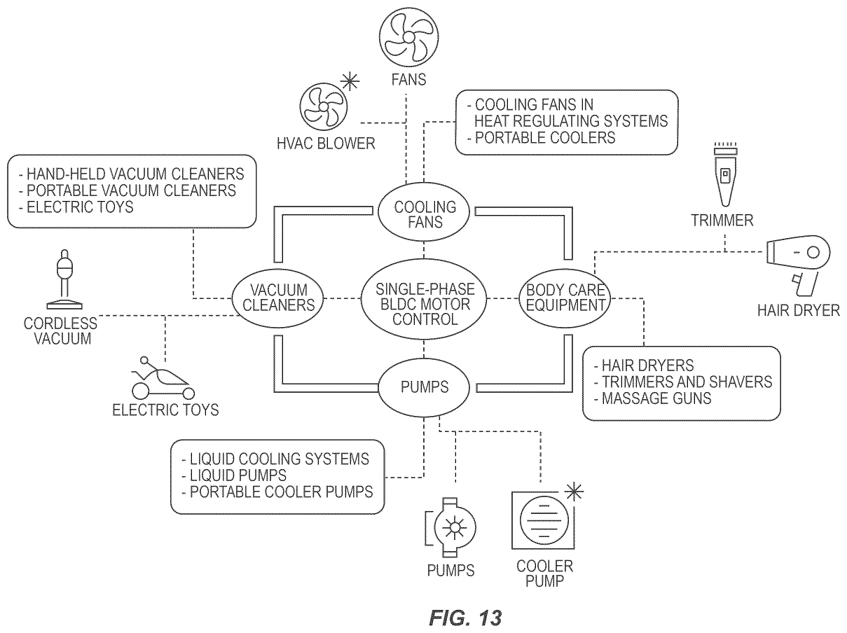

FIG. 13 illustrates some high-level applications that can be developed using IC controller devices (such as USB-PD controllers) to support single-phase BLDC motor control. These applications suggest the potential areas where BLDC motor control can be used in low-power, portable electronic gadgets, cooling systems, and home appliances. For these reasons, the gradient descent technique for adaptive commutation phase tuning in BLDC motors described herein can be universally adopted across a wide variety of brushless motor control systems to provide an optimal and robust control capabilities.

Although the present disclosure is not so limited, the following numbered examples demonstrate one or more aspects of the disclosure.

Example 1. An integrated circuit (IC) controller for controlling a brushless direct current (BLDC) motor, the IC controller comprising: a first control loop configured to calculate a duty cycle based on a sensor signal received from a position sensor in the BLDC motor; and a second control loop configured to calculate an updated commutation timing based on a present commutation timing of the BLDC motor and a current measurement representing a current sensed at the BLDC motor, wherein the IC controller is configured to continuously control commutation in the BLDC motor based on the calculated duty cycle and the updated commutation timing.

Example 2. A controller for a brushless DC (BLDC) motor having a rotor and a plurality of stator windings and powered by a power supply having a fixed input voltage, the controller comprising: a first control loop configured to adjust a duty cycle of a signal used to commutate current in the stator windings based on a difference between a measured variable and a reference value, such that the measured variable tracks the reference value; and an adaptive control loop configured to dynamically adjust a commutation phase of the current in the stator windings, such that the commutation phase settles at a value that corresponds to a minimum input current of the power supply.

Example 3. The controller of example 2, wherein the measured variable is a measured speed of the rotor and the reference value is a reference speed, and wherein the first control loop is faster than the adaptive control loop such that the measured speed tracks the reference speed despite changes made to the commutation phase by the adaptive control loop.

Example 4. The controller of example 3, wherein the adaptive control loop is configured to dynamically adjust the commutation phase with respect to a feedback signal used to generate the measured speed of the rotor.

Example 5. The controller of any of examples 2 through 4, wherein the adaptive control loop is configured to adjust the commutation phase using an iterative gradient descent algorithm.

Example 6. The controller of example 5, wherein for iteration n of the iterative gradient descent algorithm, the adaptive control loop is configured to: compare a measured value of the input current for the iteration n to a measured value of the input current for iteration n−1 of the iterative gradient descent algorithm, to generate a current delta; compare a value of the commutation phase for the iteration n−1 to a value of the commutation phase for iteration n−2 of the iterative gradient descent algorithm, to generate a commutation phase delta; divide the current delta by the commutation phase delta, to generate a commutation phase adjustment slope; scale the commutation phase adjustment slope by a phase update rate; and subtract the scaled commutation phase adjustment slope from the value of the commutation phase for the iteration n−1, to generate a commutation phase offset for the iteration n.

Example 7. The controller of example 6, wherein the phase update rate is fixed.

Example 8. The controller of example 6, wherein the phase update rate is adjustable.

Example 9. The controller of example 8, wherein the phase update rate is adjustable based on a degree of change in the commutation phase for succeeding iterations of the iterative gradient descent algorithm.

Example 10. The controller of example 8 or 9, wherein the controller is configured to decrease the phase update rate as the difference between measured values of the input current decreases for succeeding iterations of the iterative gradient descent algorithm.

Example 11. The controller of any of examples 2 through 10, wherein the adaptive control loop is configured to further adjust the commutation phase based on speed of the rotor.

Example 12. The controller of any of examples 2 through 11, wherein the adaptive control loop is configured to prevent adjustment of the commutation phase during acceleration or deceleration of the BLDC motor.

Example 13. The controller of any of examples 2 through 12, wherein the first control loop is configured to maintain constant rotor speed irrespective of load conditions and commutation phase adjustments.

Example 14. The controller of example 13, wherein T(s) is a total torque required to maintain a speed of the rotor at a specific load condition, wherein T(s) is a sum of T₁(s) output by the first control loop and T₂(s) output by the adaptive control loop, wherein the adaptive control loop is configured to adjust T₂(s) based on a value of the commutation phase value, and wherein the first control loop is configured to adjust T₁(s) as T₁(s)=T(s)−T₂(s).

Example 15. A method of controlling a brushless DC (BLDC) motor having a rotor and a plurality of stator windings and powered by a power supply having a fixed input voltage, the method comprising: adjusting a duty cycle of a signal used to commutate current in the stator windings based on a difference between a measured variable and a reference value, such that the measured variable tracks the reference value; and dynamically adjusting a commutation phase of the current in the stator windings, such that the commutation phase settles at a value that corresponds to a minimum input current of the power supply.

Example 16. The method of example 15, wherein the measured variable is a measured speed of the rotor and the reference value is a reference speed, and wherein the duty cycle is adjusted at a faster rate than the commutation phase such that the measured speed tracks the reference speed despite changes made to the commutation phase.

Example 17. The method of example 15 or 16, wherein the commutation phase is dynamically adjusted using an iterative gradient descent algorithm.

Example 18. The method of example 17, wherein for iteration n of the iterative gradient descent algorithm, dynamically adjusting the commutation phase comprises: comparing a measured value of the input current for the iteration n to a measured value of the input current for iteration n−1 of the iterative gradient descent algorithm, to generate a current delta; comparing a value of the commutation phase for the iteration n−1 to a value of the commutation phase for iteration n−2 of the iterative gradient descent algorithm, to generate a commutation phase delta; dividing the current delta by the commutation phase delta, to generate a commutation phase adjustment slope; scaling the commutation phase adjustment slope by a phase update rate; and subtracting the scaled commutation phase adjustment slope from the value of the commutation phase for the iteration n−1, to generate a commutation phase offset for the iteration n.

Example 19. The method of example 18, wherein the phase update rate is fixed.

Example 20. The method of example 18, wherein the phase update rate is adjustable.

Example 21. The method of example 20, further comprising: adjusting the phase update rate based on a degree of change in the commutation phase for succeeding iterations of the iterative gradient descent algorithm.

Example 22. The method of example 20 or 21, wherein adjusting the phase update rate based on a degree of change in the commutation phase for succeeding iterations of the iterative gradient descent algorithm comprises: decreasing the phase update rate as the difference between measured values of the input current decreases for succeeding iterations of the iterative gradient descent algorithm.

Example 23. The method of any of examples 15 through 22, further comprising: further adjusting the commutation phase based on speed of the rotor.

Example 24. The method of any of examples 15 through 23, further comprising: preventing adjustment of the commutation phase during acceleration or deceleration of the BLDC motor.

In the above description, some technical details may be presented in terms of algorithms and symbolic representations of operations performed by firmware and/or within a computer memory. These algorithmic descriptions and representations are the means used by those skilled in the data processing arts to most effectively convey the substance of their work to others skilled in the art. An algorithm is here and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared and otherwise manipulated. It has proven convenient at times, principally for reasons of common usage, to refer to these signals as bits, values, elements, symbols, characters, terms, numbers, or the like. It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “determining”, “allocating,” “dynamically allocating,” “redistributing,” “ignoring,” “reallocating,” “detecting,” “performing,” “polling,” “registering,” “monitoring,” or the like, refer to the actions and processes of a device, or similar electronic system, that manipulates and transforms data represented as physical (e.g., electronic) quantities within the system's registers and memories into other data similarly represented as physical quantities within the system memories or registers.

Embodiments descried herein may also relate to a device for performing the operations herein. Such device may be specially constructed for the required purposes (e.g., an application-specific integrated circuit, ASIC), or it may be an integrated circuit (IC) including a CPU subsystem that can execute instructions stored as firmware in a non-transitory computer-readable storage medium. Such non-transitory computer-readable storage medium may include, but is not limited to, read-only memories (ROMs), random access memories (RAMs), EPROMS, EEPROMs, flash memory, or any type of media suitable for storing electronic instructions. The term “computer-readable storage medium” should be taken to include a single medium that stores one or more sets of instructions. The term “computer-readable medium” should also be taken to include any medium that is capable of storing, encoding, or carrying a set of instructions for execution by a device and that causes the device to perform any one or more of the methodologies of the present embodiments.

Terms such as “first”, “second”, and the like, are used to describe various elements, regions, sections, etc. and are also not intended to be limiting. Like terms refer to like elements throughout the description.

As used herein, the terms “having”, “containing”, “including”, “comprising” and the like are open ended terms that indicate the presence of stated elements or features, but do not preclude additional elements or features. The articles “a”, “an” and “the” are intended to include the plural as well as the singular, unless the context clearly indicates otherwise.

The expression “and/or” should be interpreted to include all possible conjunctive and disjunctive combinations, unless expressly noted otherwise. For example, the expression “A and/or B” should be interpreted to mean only A, only B, or both A and B. The expression “at least one of” should be interpreted in the same manner as “and/or”, unless expressly noted otherwise. For example, the expression “at least one of A and B” should be interpreted to mean only A, only B, or both A and B.

The above description sets forth numerous specific details such as examples of specific systems, components, methods, and so forth, in order to provide a good understanding of several embodiments of the present disclosure. It is to be understood that the above description is intended to be illustrative and not restrictive. Many other embodiments will be apparent to those of skill in the art upon reading and understanding the above description. The scope of the disclosure should, therefore, be determined with reference to the appended claims, along with the full scope of equivalents to which such claims are entitled.

What is claimed is:

1. An integrated circuit (IC) controller for controlling a brushless direct current (BLDC) motor, the IC controller comprising:
a first control loop configured to calculate a duty cycle based on a sensor signal received from a position sensor in the BLDC motor; and
a second control loop configured to calculate an updated commutation timing based on a present commutation timing of the BLDC motor and a current measurement representing a current sensed at the BLDC motor,
wherein the IC controller is configured to continuously control commutation in the BLDC motor based on the calculated duty cycle and the updated commutation timing.

2. A controller for a brushless DC (BLDC) motor having a rotor and a plurality of stator windings and powered by a power supply having a fixed input voltage, the controller comprising:
a first control loop configured to adjust a duty cycle of a signal used to commutate current in the stator windings based on a difference between a measured variable and a reference value, such that the measured variable tracks the reference value; and
an adaptive control loop configured to dynamically adjust a commutation phase of the current in the stator windings, such that the commutation phase settles at a value that corresponds to a minimum input current of the power supply.

3. The controller of claim 2, wherein the measured variable is a measured speed of the rotor and the reference value is a reference speed, and wherein the first control loop is faster than the adaptive control loop such that the measured speed tracks the reference speed despite changes made to the commutation phase by the adaptive control loop.

4. The controller of claim 3, wherein the adaptive control loop is configured to dynamically adjust the commutation phase with respect to a feedback signal used to generate the measured speed of the rotor.

5. The controller of claim 2, wherein the adaptive control loop is configured to adjust the commutation phase using an iterative gradient descent algorithm.

6. The controller of claim 5, wherein for iteration n of the iterative gradient descent algorithm, the adaptive control loop is configured to:
compare a measured value of the input current for the iteration n to a measured value of the input current for iteration n−1 of the iterative gradient descent algorithm, to generate a current delta;
compare a value of the commutation phase for the iteration n−1 to a value of the commutation phase for iteration n−2 of the iterative gradient descent algorithm, to generate a commutation phase delta;
divide the current delta by the commutation phase delta, to generate a commutation phase adjustment slope;
scale the commutation phase adjustment slope by a phase update rate; and
subtract the scaled commutation phase adjustment slope from the value of the commutation phase for the iteration n−1, to generate a commutation phase offset for the iteration n.

7. The controller of claim 6, wherein the phase update rate is fixed.

8. The controller of claim 6, wherein the phase update rate is adjustable.

9. The controller of claim 8, wherein the phase update rate is adjustable based on a degree of change in the commutation phase for succeeding iterations of the iterative gradient descent algorithm.

10. The controller of claim 8, wherein the controller is configured to decrease the phase update rate as the difference between measured values of the input current decreases for succeeding iterations of the iterative gradient descent algorithm.

11. The controller of claim 2, wherein the adaptive control loop is configured to further adjust the commutation phase based on speed of the rotor.

12. The controller of claim 2, wherein the adaptive control loop is configured to prevent adjustment of the commutation phase during acceleration or deceleration of the BLDC motor.

13. The controller of claim 2, wherein the first control loop is configured to maintain constant rotor speed irrespective of load conditions and commutation phase adjustments.

14. The controller of claim 13, wherein T(s) is a total torque required to maintain a speed of the rotor at a specific load condition, wherein T(s) is a sum of T₁(s) output by the first control loop and T₂(s) output by the adaptive control loop, wherein the adaptive control loop is configured to adjust T₂(s) based on a value of the commutation phase value, and wherein the first control loop is configured to adjust T₁(s) as T₁(s)=T(s)−T₂(s).

15. A method of controlling a brushless DC (BLDC) motor having a rotor and a plurality of stator windings and powered by a power supply having a fixed input voltage, the method comprising:
adjusting a duty cycle of a signal used to commutate current in the stator windings based on a difference between a measured variable and a reference value, such that the measured variable tracks the reference value; and
dynamically adjusting a commutation phase of the current in the stator windings, such that the commutation phase settles at a value that corresponds to a minimum input current of the power supply.

16. The method of claim 15, wherein the measured variable is a measured speed of the rotor and the reference value is a reference speed, and wherein the duty cycle is adjusted at a faster rate than the commutation phase such that the measured speed tracks the reference speed despite changes made to the commutation phase.

17. The method of claim 15, wherein the commutation phase is dynamically adjusted using an iterative gradient descent algorithm.

18. The method of claim 17, wherein for iteration n of the iterative gradient descent algorithm, dynamically adjusting the commutation phase comprises:
comparing a measured value of the input current for the iteration n to a measured value of the input current for iteration n−1 of the iterative gradient descent algorithm, to generate a current delta;
comparing a value of the commutation phase for the iteration n−1 to a value of the commutation phase for iteration n−2 of the iterative gradient descent algorithm, to generate a commutation phase delta;
dividing the current delta by the commutation phase delta, to generate a commutation phase adjustment slope;
scaling the commutation phase adjustment slope by a phase update rate; and
subtracting the scaled commutation phase adjustment slope from the value of the commutation phase for the iteration n−1, to generate a commutation phase offset for the iteration n.

19. The method of claim 18, wherein the phase update rate is fixed.

20. The method of claim 18, wherein the phase update rate is adjustable.

21. The method of claim 20, further comprising:
adjusting the phase update rate based on a degree of change in the commutation phase for succeeding iterations of the iterative gradient descent algorithm.

22. The method of claim 20, wherein adjusting the phase update rate based on a degree of change in the commutation phase for succeeding iterations of the iterative gradient descent algorithm comprises:
decreasing the phase update rate as the difference between measured values of the input current decreases for succeeding iterations of the iterative gradient descent algorithm.

23. The method of claim 15, further comprising:
further adjusting the commutation phase based on speed of the rotor.

24. The method of claim 15, further comprising:
preventing adjustment of the commutation phase during acceleration or deceleration of the BLDC motor.
